(19) United States
(12) Patent Application Publication
(10) Pub. No.: US 2012/0316948 A1
(43) Pub. Date: Dec. 13, 2012

(54) SYSTEMS AND METHODS FOR SHARING AND VERIFICATION OF PROMOTIONAL OFFERS

(76) Inventors: Blake Alan Shipley, Cincinnati, OH (US); Troy James Davis, Norwood, OH (US)

(21) Appl. No.: 13/495,125

(22) Filed: Jun. 13, 2012

Related U.S. Application Data
(60) Provisional application No. 61/496,549, filed on Jun. 13, 2011.

(51) Int. Cl. G06Q 30/02

(52) U.S. Cl. 705/14.23; 705/14.1

(57) ABSTRACT

Systems and methods are provided for displaying promotions within an electronic social networking environment. Coupons or vouchers can be claimed by users of the social network. Upon redemption of the coupon or voucher, the systems and methods described herein can validate the coupon or voucher.

### CROSS-REFERENCE TO RELATED APPLICATION

This application claims the benefit of U.S. provisional patent application Ser. No. 61/496,549, filed on Jun. 13, 2011, entitled “INCENTIVIZING SHARING OF PROMOTIONS USING SOCIAL NETWORKS AND VALIDATING PROMOTIONAL OFFERS,” the disclosure of which is hereby incorporated by reference herein in its entirety.

### TECHNICAL FIELD

The systems and methods described below relate generally to the field of sharing promotions and validating promotional offers. More particularly, the systems and methods relate to providing incentives, such as rewards for a particular sharing activity, to individuals who add a promoter to their social network or publish a promotion on their social network. The system and method also relate to the field of real-time verification of promotions at the time of purchase, for example at a merchant's point-of-sale terminal.

### BACKGROUND

The emergence of global communication networks such as the Internet and major cellular networks has precipitated interaction between users and other network entities. Not only are cellular and IP networks now a principal form of communications, but also a central means for interacting with other users for most purposes. Social network services facilitate the development of online communities of people who share interests and/or activities, by enabling them to build relationships, and exchange information and content. Many social network services are web based and provide a variety of means facilitating communication between users.

### BRIEF DESCRIPTION OF THE DRAWINGS

The present disclosure will be more readily understood from a detailed description of some example embodiments taken in conjunction with the following figures:

FIG. 1 is a block diagram of an implementation of a bonus incentive system to incentivize users to post promotions on the user's social network page.

FIG. 2 is a block diagram of an implementation of a bonus incentive system to incentivize users to share promotions from a promoter's social networking page.

FIG. 3 is a block diagram of an implementation of a bonus incentive system to incentivize users to share promotions with members of their social network.

FIG. 4 is a block diagram of an implementation of a bonus incentive system to verify promotion-related activities of users and members of the user's social network and present promotions based on those promotion-related activities.

FIG. 5 is a flow diagram of an example operation of a social network bonus incentive system.

FIG. 6 is a flow diagram of an example operation of a bonus incentive system for users who initiate social networking actions in response to receiving an offer from a promoter.

FIGS. 7A-7B are block diagrams of example implementations of offer verification systems.

FIG. 8 is a flow diagram of an example operation of a real-time offer verification system.

### DETAILED DESCRIPTION

Various non-limiting embodiments of the present disclosure will now be described to provide an overall understanding of the principles of the structure, function, and use of the promotional sharing and verification systems and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

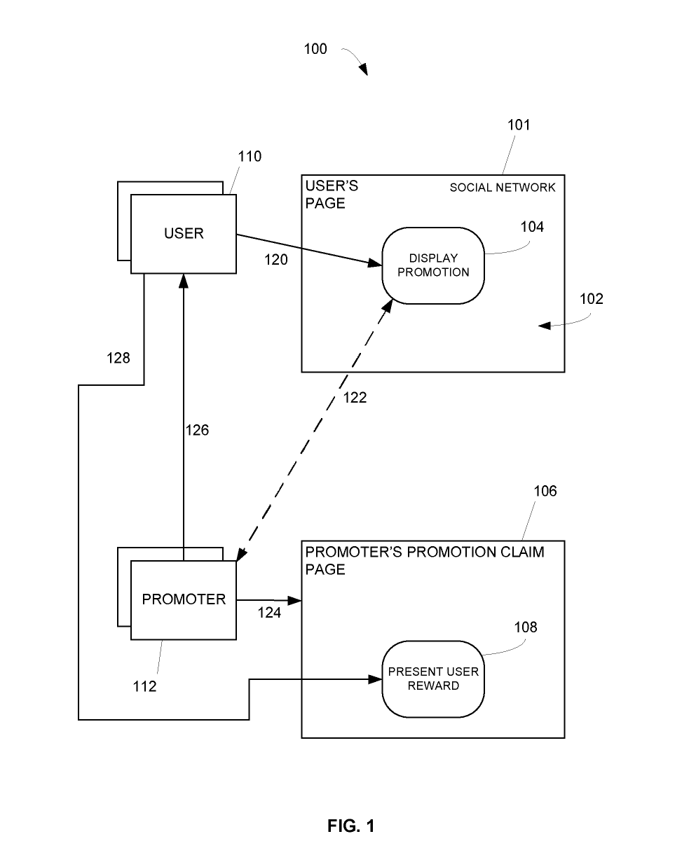

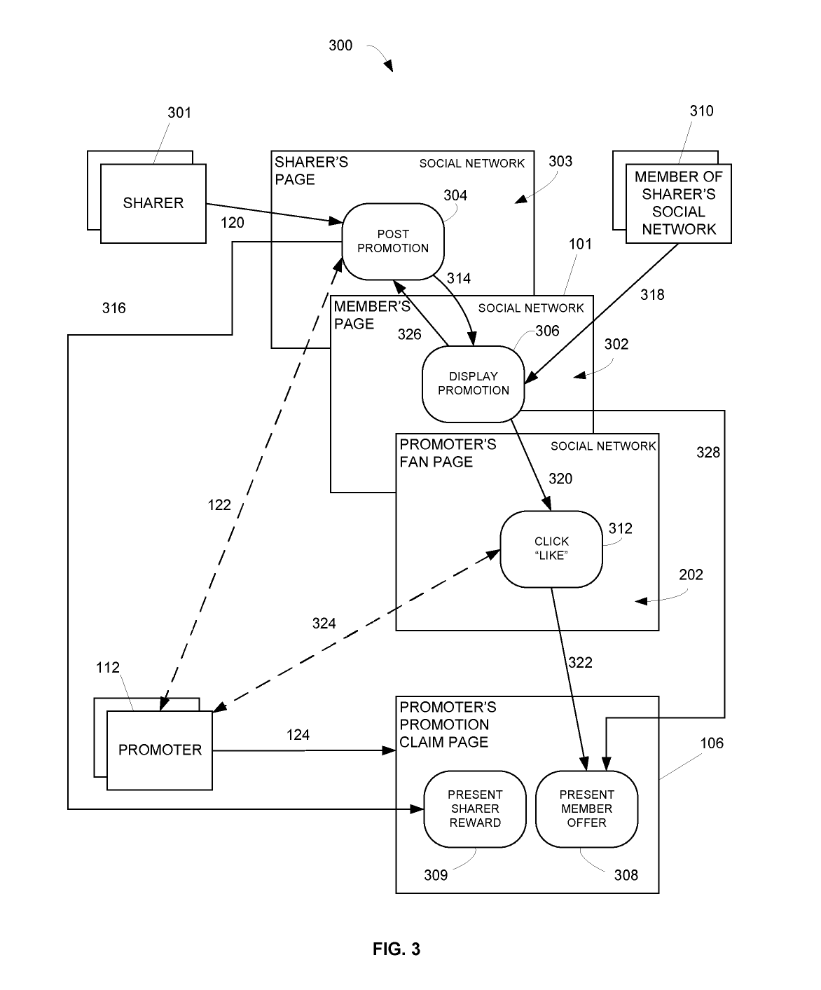

FIG. 1 is a block diagram of a system 100 for incentivizing the sharing of promotions using a social network 101. A social network 101 can be represented as a graph of interconnected nodes where each node represents a member of the social network 101 and each connection between nodes represents a social connection between members. A promoter 112, for example a business or a marketer, can offer an incentive to a user 110 to display a promotion 104 on the user's 110 social network page, or user's page 102. The promotion 104 can include a coupon, a discount, an offer, a monetary award, an offer of a gift card, a contest entry, or any other kind of reward or promotion. In addition, the promotion can also include information about a business, a product, a service, or other marketing information. The promoter 112 can configure 124 a promoter's promotion claim page 106 to present a reward 108 to a user 110 for displaying the promotion 104. When a user 110 provides promotional information to others, it is generally the recipient of the promotion that benefits from the promotion, or it is the business or marketer that benefits from the word-of-mouth advertising. Therefore, beyond the personal satisfaction of sharing information with others, there is no significant incentive for users 110 to share information with others in their social network 101 or to allow marketers to advertise through their user's page 102. By presenting a reward 108 to the user 110, a promoter 112 incentivizes a user 110 to display a promotion 102 for the promoter 112 on their user's page 102.The user 110 can perform a number of interactions 120 on the social network 101 to display the promotion 104. For example, the user 110 can log on to the social network 101, can view their user's page 102, and can create a post to display a promotion 104 on their user's page 102. The promoter 112 can verify 122 the display of the promotion 104 on the user's page 102. In a configuration, the interactions 120 include the operation of using the promoter's 112 software or systems to generate the post, that can include adding one or more of the user's own personal comments to the post, and the operation of verifying 122 can be performed by receiving a confirmation of a successful posting from the social network 101 indicating that the user's page 102 is displaying the promotion 104. In another configuration, if the promoter 112 is a member 310 (see e.g., FIG. 3 and accompanying description) of the user's 110 personal social network 101, then the promoter 112 can receive the post and become aware that the user 110 has displayed the promotion 104 on their user's page 102. The promoter 112 can periodically or randomly inspect the user's page 102 for posts that display the promotion 104, for example to verify that a post has not been deleted from the user's page 102 for a designated period of time. In another configuration, the user 110 can configure a post so that the promoter 112 receives a copy of the post, so that even if the promoter 112 is not in the user's 110 social network 101 and cannot see the user's page 102, the promoter 112 will still receive a confirmation of the posting. In another configuration, the user can send a message or separate confirmation to the promoter 112 to provide evidence that a post displaying the promotion 104 has been posted to the user's page 102.

Although the system 100 and method presented describe posts to a user's page 102 on a social network 101, other means of sending information to third parties and other forms of social media are also considered, such as email messages, a short message service or SMS message, a message from a web log, and even phone, voicemail, or other audible messages. Web logs are commonly referred to as blogs and can include microblogs and blog messages.

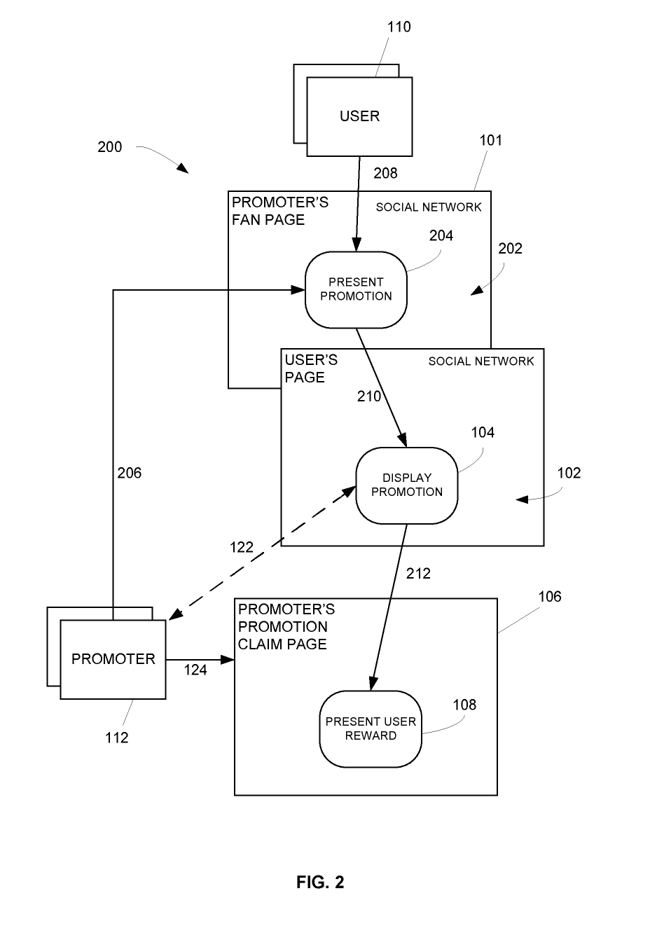

The promoter 112 can verify 122 the post displaying the promotion 104 various different ways and present a reward 108 to the user 110. In an example, the promoter 112 can present a reward 108 to the user 110 on the promoter's promotion claim page 106. In various configurations, the promoter's promotion claim page 106 can be a separate web page as shown, can be part of the promoter's fan page (shown in FIG. 2, reference 202), can be a pop-up page, or can be any other suitable kind of web page or pop-up page as would be understood by one familiar in the art. The promoter 112 can send a communication 126 to the user 110 to inform the user 110 that the post was verified and provides a link, such as a uniform resource locator (URL) or equivalent, by email or by using the social network 101 that provides a link to the promoter's promotion claim page 106. The user 110 can follow 128 the URL, for example by clicking on the link or entering the URL into their web browser, to be directed to the promoter's promotion claim page 106. The promoter's promotion claim page 106 can present a reward 108 to the user 110, that can be, in specific examples, a monetary award, a coupon, an offer of a discount, an offer of a gift card, a contest entry, or any other kind of reward or promotion. In another configuration, the promoter 112 can send a communication 126 or message to the user 110 that can include text or graphics that presents the reward 108 directly to the user 110 without using a separate web page, for example by providing a coupon in an email for the user 110 to print out. In this configuration, the promoter's promotion claim page 106 can be eliminated, or the promoter's promotion claim page 106 can function as a secondary way for users 110 to retrieve or view past communications 126 and be presented the reward 108 again, for example if the user 110 misplaces the original communication 126 and needs to reprint a coupon.

In various configurations, the promoter 112 is a service provider or other entity that coordinates or otherwise facilitates the presentment of the promotion 104 within the social network 101. The promotion 104 may be affiliated with a party or entity that is different from the promoter 112 and is using the promoter 112 for its promotion presentment and tracking services. In various embodiments, the promoter 112 may also coordinate, or otherwise facilitate, the redemption or claiming of user award 108. Thus, in various configurations, the promoter 112 may be tracking, verifying, and coordinating the placement of promotions for a wide variety of other entities. The verification 122 referred to above can be performed or achieved by the promoter 112 through the placement or posting of the particular promotion 104 on a user's page 102.

FIG. 2 is a block diagram of a system 200 for incentivizing the sharing of posts from a promoter's fan page 202 using a social network 101. A promoter 112 can offer an incentive to a user 110 to display a promotion 104 selected from the promoter's fan page 202 on the user's 110 social network page, or user's page 102. The promoter 112 can create a post on the promoter's fan page 202 that presents a promotional offer 204, which in turn can present a reward 108 to the user 110 than is different from what is being displayed in the promotion 104. In some configurations, the user 110 can be rewarded differently for the act of displaying the promotion 104 than what is being displayed in the promotion 104. For example, a user 110 can receive a $5 off coupon for displaying a $7 coupon that is only available only to new customers of a particular business. The promoter 112 can configure 124 a promoter's promotion claim page to present the reward 108 to the user 110 to incentivize or encourage the user 110 to display the promotion 104. In other configurations, the reward 108 can be the same as the promotional offer 204. In a configuration, the promoter 112 can use a webpage or software that is separate from the social network 101 to presents a promotional offer 204.

The user 110 can perform a number of interactions 208 on the social network 101 to display the promotion 104 on their user's page 102. For example, the user 110 can log on to the social network 101 and can view the promoter's fan page 202. The promoter's fan page 202 can present the promotional offer 204 that the user 110 clicks on to share the promotion 210 with the user's 110 social network 101. The social network 101 can display the promotion 104 on the user's page 102 by creating a post on the user's page 102. The user 110 can be redirected 212 to the promoter's promotion claim page 106 where the user 110 is presented the reward 108 for displaying the promotion 104. The promoter 112 can also verify 122 the display of the promotion 104 on the user's page 202 prior to redirecting 212 the user 110 to the promoter's promotion claim page 106 or prior to presenting the reward 108 to the user 110. In a configuration, the interactions 208 can include the operation of viewing an example post on the promoter's fan page 202 and adding comments to the post before sharing the promotion 210 on the user's page 102. The operation of verifying 122 can be performed by receiving a confirmation from the social network 101 of a successful posting thereby indicating that the user's page 102 is displaying the promotion 104.

Although the system 200 and methods presented are described as posts on a promoter's fan page 202 and a user's page 102 on a social network 101, as described above for FIG. 1, the system 200 and methods presented are also applicable to other forms of social media including, but not limited to email, SMS messages, blogs and blog messages, and any other visual, audio, or multimedia type of messaging.

FIG. 3 is a block diagram of a system 300 for incentivizing the sharing of promotions with members of the sharer's 301 social network 101, or members 310. A sharer 301 is similar to the user 110 of FIGS. 1 and 2, but is designated sharer 301 to better distinguish the sharer 301 from a member 310 of the sharer's 301 social network because member 310 can also be a user 110 as described in FIGS. 1 and 2. A promoter 112 can offer an incentive to a sharer 301 to post a promotion 304 on the sharer's 301 social network page, or sharer's page 303, that the social network 101 shares with members 310 of the sharer's 301 social network 101. The promoter 112 can configure 124 a promoter's promotion claim page to present a reward 108 to the sharer 301 once the sharer 301 posts the promotion 304 and to present a referral promotion 308 to the member 310 of the sharer's 301 social network 101. The sharer 301 can perform a number of interactions 120 on the social network 101 to post the promotion 304 on their sharer's page 303. For example, the sharer 301 can log on to the social network 101 and view their sharer's page 303. The sharer 301 can post the promotion 304 on their sharer's page 303, for example by viewing a post on the promoter's fan page 202, adding comments to the post, and posting the promotion 304 to their sharer's page 303. The operation of verifying 122 can be performed by receiving a confirmation from the social network 101 indicating that the sharer 301 posted the promotion 304. In some configurations, the promoter 112 facilitates the posting of the promotion 304 to the sharer's page 303. Thus, the verification 122 is satisfied once the promoter successfully posts the promotion 304. The social network 101 can distribute 314 posts from the sharer's page 303 to one or more members' pages 302 selected from the members 310 of the sharer's 301 social network 101. The privacy settings of the sharer 301 and the privacy settings of the individual members 310 of the sharer's 301 social network 101 can determine to which members 310 the social network 101 distributes 314 posts and which members' pages 302 actually display the posted promotion 306. In configurations where the promoter 112 facilities the posting of the promotion 304 across various pages in a user's social network, the virality chain of a particular promotion can be maintained by the promoter 112. The promoter 112 can therefore track the activity related to a particular promotion, or collection of promotions, across the social network. Further, the promoter 112 can monitor which particular user shares which promotions with other members, which of those members share the promotion, and so forth.

When a member 310 of the sharer's 301 social network 101 views 318 their member's page 302, the member's page 302 can display the posted promotion 306 which can also provide a link to the promoter's fan page 202. The member 310 can select 320 the link, for example by clicking on the link, to go to the promoter's fan page 202, and can perform further actions, such as clicking on a “Like” button 312. Clicking on a “Like” button 312 can redirect 322 the member 310 to the promoter's promotion claim page 106 where the member 310 can be presented an offer 308, for example a coupon, a discount, a contest entry, a gift card offer, a special offer, or any other kind of promotion. In another configuration, the link can redirect 328 the member 310 directly to the promoter's promotion claim page 106.

In a configuration, the member 310 can also share the promotion 326 with other people in the member's 310 social network 101. When the member 310 shares the promotion 326, the member 310 in effect becomes a sharer 301. Posting the promotion 304 to their member's page 302 facilitates the spread of the promotion to other people in the member's 310 social network 101, who can then also become sharer's 301 thereby allowing the promotion to spread across the social network 101 in an approximately geometric fashion. For posting the promotion 304, the sharers 301 can be provided a link 316 to take the sharers 301 to the promoter's promotion claim page 106 where the sharers 301 can be presented the reward 108 for posting the promotion 304. A sharer 301 can activate and use the reward 108, for example by printing out a coupon and presenting 404 the coupon for redemption at a store 401.

The sharer 301 can be rewarded somewhat differently from what is being displayed in the posted promotion 306. The sharer 301 can be presented a reward 108 that has a value that is the same as, more than, or less than what the member 310 receives. Also, the sharer 301 can be presented a reward 108 that is contingent upon some threshold criteria being met. In an example, the sharer 301 can be presented the reward 108 only once a certain number of members 310 display in the posted promotion 306. In another example, the sharer 301 can be presented a reward 108 that increases in value as more members 310 display the posted promotion 306.

In a configuration, the promoter 112 can verify 122 the display of the promotion 104 on the sharer's page 303 prior to providing the link 316 to the sharer 301 to the promoter's promotion claim page 106, or prior to presenting the reward 309 to the sharer 301. The promoter 112 may not be able to see the members' pages 302 of members 310 of the sharer's 301 social network 101, depending on the privacy settings of the members 310. Therefore, the promoter 112 may not be able to verify whether any members 310 of the sharer's 301 social network 101 actually displayed the promotion 306. However, the promoter 112 can view 324 the later actions of the member 310, such as the clicking on the “Like” button 312 on the promoter's fan page 202 by a member 310, or if when presented the offer 308 the member 310 takes further action to claim the promotional offer, for example by entering personal information to activate the promotional offer.

Although the system 300 and method presented are described as posts to a member 310 of the sharer's 301 social network 101 and their member's page 302, the system 300 and methods presented are also applicable to sharing of information with any third party or third parties whether they are in the sharer's 301 social network 101, friends, acquaintances, or people the sharer 301 knows how to reach through an appropriate form of communications, whether electronic or otherwise. Moreover, as with FIGS. 1 and 2, the system 300 and method are also applicable to other forms of social media including, but not limited to email, SMS messages, blogs and blog messages, and any other visual, audio, or multimedia type of messaging.

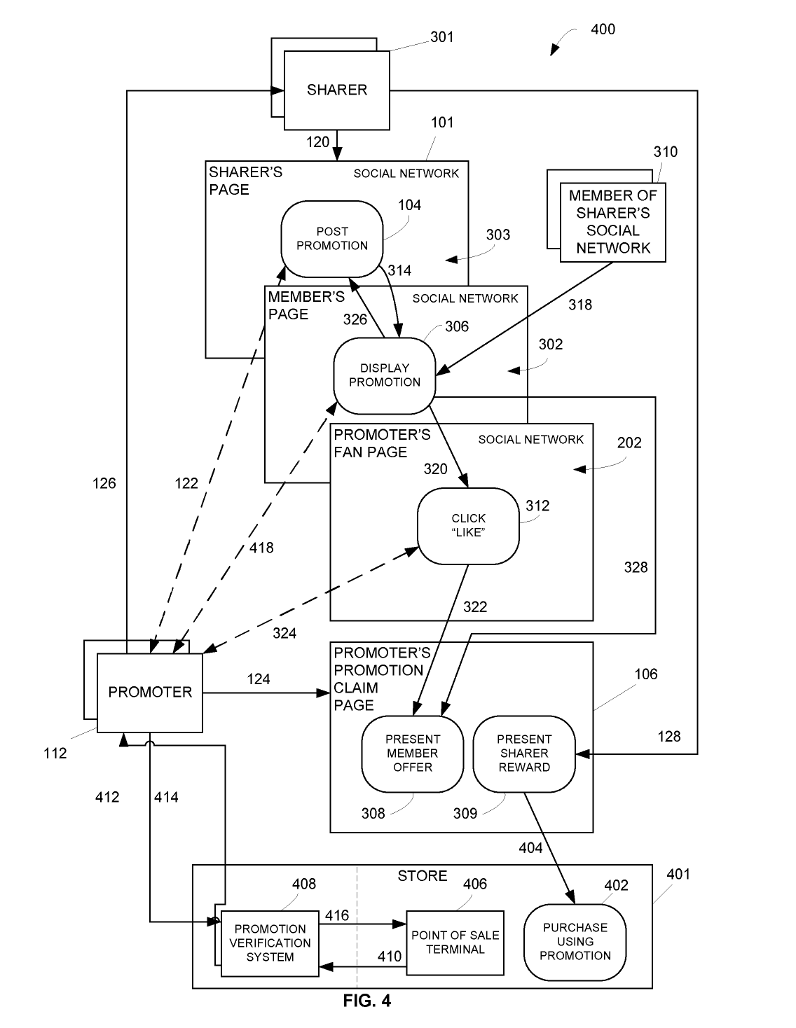

FIG. 4 is a block diagram of a system 400 for incentivizing the sharing of promotions with members 310 of the sharer's 301 social network 101, and verifying promotion-related activities of sharers 301 and members 310 of their social network 101 in order to present promotions based on those promotion-related activities. The system 400 functions similar to the systems 100, 200, 300 described in FIGS. 1, 2, and 3, in that the sharer 301 can interact 120 with the social network 101 to post a promotion 104 on the sharer's page 303; the social network 101 can distribute 314 posts from the sharer's page 303 to members' pages 302; members 310 can view 318 their member's page 302 that displays the posted promotion 306; and the member 310 can select 320 the post by clicking on a link. The link can allow the member 310 to view the promoter's promotion claim page 106. The promoter's promotion claim page 106 can present an offer 308 to the member 310, which the member 310 can activate and use, for example by printing out a coupon and presenting 404 the coupon for redemption at a store 401. In another example, the coupon can be used immediately for an online purchase.

In a configuration, the sharer 301 takes the coupon and presents 404 the coupon to a store 401 where the sharer 301 can use the coupon to purchase 402 a product or service. Although described in terms of a sharer 301 presenting 404 a coupon to a store 401, it should be noted that the system 400 and method would be similar for the member 310 presenting 404 a coupon to a store 401. The coupon can be the entire payment for the product or service, or the coupon can be a discount or other form of promotion or offer. A promotion verification system 408 at the store 401 allows the store 401 to verify and authenticate the coupon to ensure that the coupon is genuine and not, for example, an unauthorized copy. When the sharer 301 presents 404 the coupon to a register clerk for redemption, for example when paying at a point-of-sale terminal 406, the clerk enters 410 the coupon information into the promotion verification system 408, for example by scanning a bar code on the coupon or any other authentication or identifying indicia on the coupon. The promotion verification system 408 can perform an authentication request 412 for the coupon with the promoter 112. The promoter 112 can send an authentication answer 414 back to the promotion verification system 408 indicating whether or not the coupon is authentic, has not-expired, and has not yet been previously used by the sharer 301. If the promotion verification system 408 indicates that the coupon is valid, the clerk can apply 416 the coupon to the current purchase at the point-of-sale terminal 406. In a configuration, the point-of-sale terminal 406 and the promotion verification system 408 can be connected via a network connection or communications link so that the coupon can be directly applied 416 to the current purchase.

While the promotion verification system 408 is illustrated in FIG. 4 as being located within the store 401, in other configurations, the promotion verification system 408 can be remote from the store 401. For example, the promotion verification system 408 can be integrated into the promoter 112 or it can be an entity separate from the store 401 and the promoter 112. The coupon information can be provided to the promotion verification system 408 by any acceptable data delivery technique. For example, a promotion verification device (such as a hand held scanner, for example) at the store 401 can be used to optically scan a bar code of the coupon and provide the data to a remote promotion verification system 408.

Furthermore, while the promotion verification process in FIG. 4 is shown as being a real-time process, other configurations can authenticate or verify the coupon subsequent to redemption. For example, in some configurations a coupon clearinghouse authenticates or validates the coupon after the coupon has been redeemed at the store 401. Once the coupon is passed through the authentication process, if it is found to be counterfeit, invalid, or otherwise not acceptable, the promoter 112 can take a variety of action. For example, the user that redeemed the non-validated coupon (such as sharer 301 or member 310) can be blacklisted by the promoter 112 from receiving additional coupons, sharing promotions, claiming rewards, and so forth. In other words, since the coupons being presented at the store 401 can be tied to a particular user through a unique identifier, potentially nefarious activity can be tracked by the promoter 112 to a particular user.

As with FIGS. 1, 2, and 3, and associated descriptions, although the system 400 and method presented are described in terms of a social network 101, the system 400 and methods presented are also applicable to sharing of information with any third party or third parties using other forms of social media including, but not limited to email, SMS messages, blogs and blog messages, and any other visual, audio, or multimedia type of messaging. Further, although the authentication process is described in terms of printed coupons, the systems 400 and methods are also applicable to other forms of discounts, offers, coupons, advertising, promotions, and the like, whether printed, communicated electronically, or provided in a verbal, audible, or written format. Further, although the authentication process is described in terms of coupons being distributed and received through a social network, the systems and methods described herein are also applicable to coupons distributed and received through other vehicles. For example, the promotion verification techniques described herein are application to verify or authenticate any coupon that includes an identifiable code. The identifiable code can be, for example, a unique code associated with a particular user. Further, although the system 400 and methods are described in terms of stores 401 that sell physical goods, the system and methods presented are also applicable to other types of transactions, for example services from providers of services and entrance to venues such as theme parks and other entertainment venues.

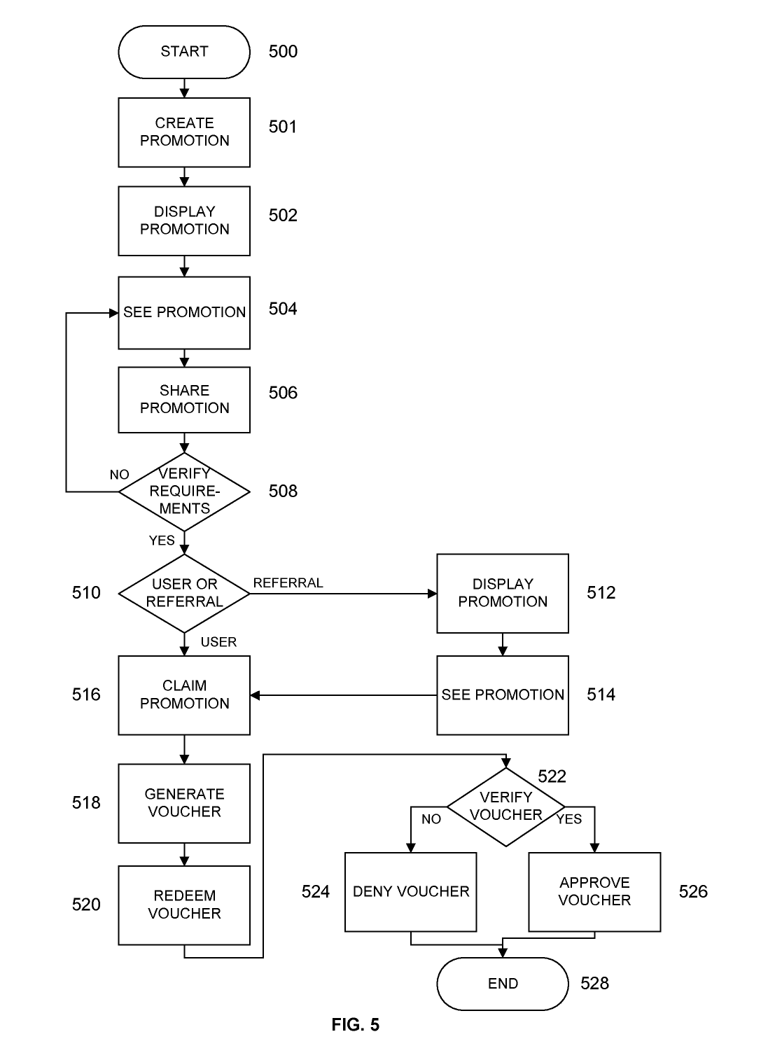

Referring now to FIG. 5, an exemplary flow diagram of the operation of a system 100, 200, 300, 400 for providing a social network bonus is presented. Operation starts with start block 500 labeled START. Processing continues to process block 501 where the promotion is created by the promoter, for example a business or a marketer. The promotion can be any kind of coupon, discount, offer, contest entry, reward, or other promotion. In a configuration, the user and the members of the user's social network can receive the same promotion. In another configuration the user and the members of the user's social network can receive different promotions. For example, in a configuration the user can receive a monetary reward for the referral, while the member of the user's social network can receive a coupon. In another example, the referral can receive a first time coupon that is greater in value than the coupon for the referring user. In another configuration, the user and the referral, or member of the user's social network, must both claim the promotion or reward before either one receives the promotion or reward. For example, the referral may have to “Like” a fan page of the business or marketer, or purchase a gift card, before the user can receive a promotion or reward for the act of referring the member of the user's social network. In another configuration, the user can claim a promotion simply by performing the act of sharing the promotion, independent of whether or not the members of the user's social network actually see or attempt to use or claim the promotion. For example, the user can receive a promotion for posting a favorable comment or review of the business's product, or for posting a link to the business's or marketer's fan page.

Processing continues to process block 502 where a promotion is displayed to a user. The promotion can be displayed by any marketing means, including but not limited to an email, an SMS or text message, a URL, a blog or blog message, a message within the social network, a post within the social network, a fan page within the social network, a picture, an advertisement such as a newsprint advertisement, an in-store advertisement, or an advertisement of any kind. For clarity of exposition, the message will be described as a computer message that is delivered over a network and displayed to a user on their computing device such as a mobile computing device or computer, however this is not intended to limit the disclosure to a particular message type or configuration. Processing continues to process block 504. In process block 504, the user can see the promotion, for example by seeing the message displayed on their computing device. However, it is possible for the user to claim a promotion without the promotion being displayed on their computing device, for example a can type a URL or a text string to type to activate the promotion, or the promotion can be activated using a mobile computing device through operations such as scanning a quick response code or QR code, grabbing an image of a bar code at a store, or swiping an RFID-tagged device, or similar technology. For purposes of this disclosure the user “sees” the promotion, whether or not it is in a format that is readable or understandable by the user or a computer. Processing continues to process block 506.

At process block 506, the user can share the promotion with members of their social network. For example, sharing can comprise placing a specific post on their social network page, or user's page. In another example, sharing can comprise posting the promotion, or a link to the promotion, on the social network page of another person. Sharing can also comprise sending an electronic message to another member of their social network, for example a message containing a link, URL, QR code, or other identifier of the promotion. Sharing can also comprise simply notifying the member of their social network of the promotion, for example by word-of-mouth. However for verifying the promotion in decision block 508, a promoter can require a way of correlating the member of their social network with the user's activities in order to receive the promotion or reward. After sharing the promotion in process block 506, processing continues to decision block 508. It is noted that while sharing 506 is illustrated in the flow diagram of FIG. 5, sharing is not necessarily required in all configurations. In fact, in some configurations, sharing is merely optional and is not required for a user to claim a promotion.

In decision block 508, the requirements for the promotion are verified. In a configuration, the business or marketer sponsoring the promotion can determine whether the user is eligible for the social bonus reward for sharing the promotion. There are numerous ways that the sharing of the promotion can be verified. In a first example, the business or marketer can verify that the promotion is posted on the user's social networking page. This can be performed manually by a person or automatically by a computer. In a second example, if the business or marketer can view a referred member's social networking page, the business or marketer can verify whether the promotion has been posted on the member's social networking page. In a third example, if the promotion was delivered by a message such as email, the business or marketer can require that they be copied on the email, for example by requiring the promoter's email address be including in the to:, cc:, or bcc: fields of an email. In a fourth example, the user may need to pre-identify the member of their social network to the business or marketer. For example, if the promotion was delivered to the member of their social network by word-of-mouth, in order to receive the social bonus reward the user generally would need to pre-identify that member of their social network to the business or marketer prior to, or in conjunction with, the member of their social network attempting to claim the promotion.

Processing then continues to decision block 510. In decision block 510, processing can continue to process block 516 or process block 512. For a user, processing continues to process block 516, for example by directing the user to a page where the user can claim the promotion. For a referral, or the member from the user's social network who can receive notice of the promotion from the user, processing continues to process block 512. In process block 512, the promotion can be created by the promoter and displayed to the member of the user's social network. In a configuration, the promotion can be a coupon, a discount, an offer of a gift card, a favorable comment or review, a fan page of the business or marketer, including for example a “Like” button, or any other promotion. In another configuration, the promotion can be identical or similar to the promotion displayed to the user in process block 502. The displaying can be similar to, or a variation of, the displaying described in process block 502. Processing continues to process block 514 where the user sees the displayed promotion. Processing continues to process block 516.

In process block 516 the user or the member of the user's social network, or referral, can claim a promotion as described in process block 501. In an example configuration, the user and the referral can claim an identical promotion, for example a coupon, a discount, or an entry into a contest. In another configuration, the user can claim a reward that is different than the referral, for example a user may receive a monetary award for the referral. In another example, the referral can receive a first time coupon or discount that is greater than the reward received by the user. In another configuration, the user and the referral must both claim the promotion or reward before either one receives the promotion or reward. In a configuration, the user can claim a promotion simply by performing the act of sharing the promotion, independent of whether or not the members of the user's social network actually see or attempt to use or claim the promotion. Processing then continues to process block 518.

In process block 518, a voucher for the promotion or reward can be generated. The voucher can be in any form, for example a printable coupon, an email containing a code or bar code for claiming the discount or promotion. Processing then continues to process block 520 where the user or member of the user's social network can attempt to redeem the voucher. For example, the user or member of the user's social network can attempt to use the voucher online to obtain the discount, for example through a virtual storefront. In another example, the user or member of the user's social network can take the voucher to a brick-and-mortar establishment or store to redeem the coupon, discount, or reward. Processing continues to decision block 522.

In decision block 522 the voucher can be authenticated and verified for use by the user. The voucher can be checked to determine if the voucher has been previously used or has expired. If the voucher is authentic and has not expired or been previously used, processing continues to process block 526. If the voucher is an unauthorized copy, is expired, has previously been used, or otherwise is invalid, processing continues to process block 524. In process block 524, the voucher is denied and the promotion, discount, or reward is not given to the customer. In process block 526 the voucher is approved and the merchant or store is advised to allow the customer to receive the promotion, discount, or reward. In a configuration, merchant's or store's point of sale terminals are configured to automatically permit the voucher to be used, and the discount or promotion given, once the voucher has been approved. Operation concludes with end block 528 labeled END.

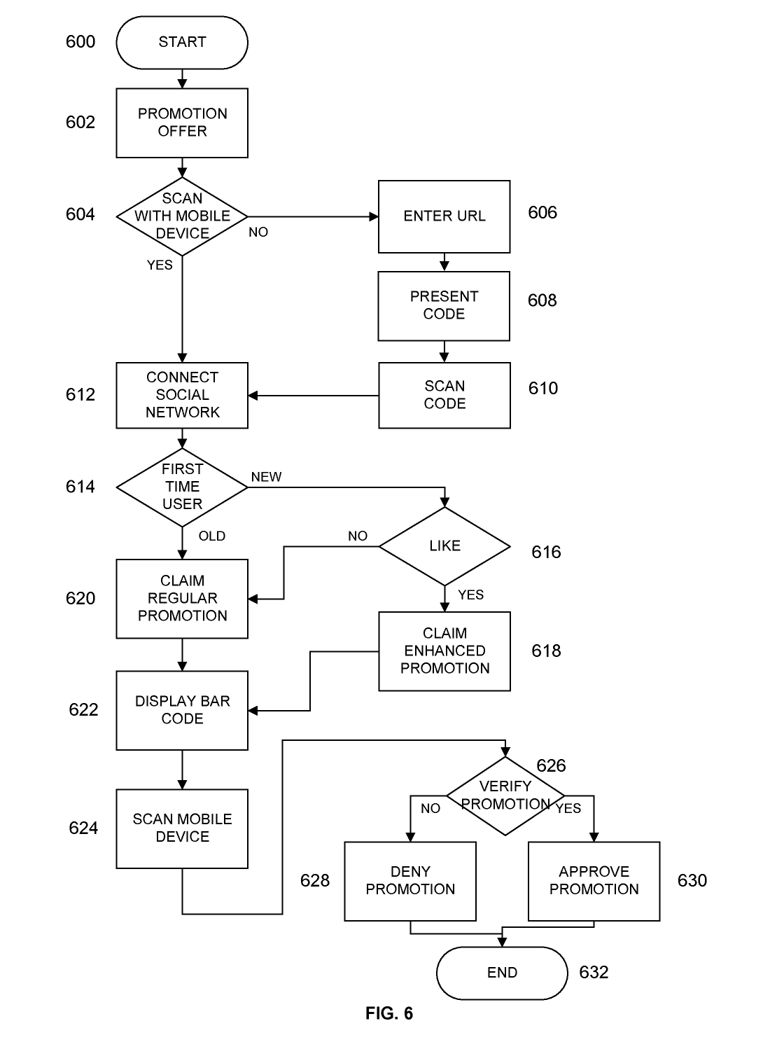

Referring now to FIG.6, an exemplary flow diagram is presented of the operation of a system for providing a social network bonus to users who initiate social networking actions in response to receiving a promotional offer. Operation starts with start block 600 labeled START. Processing continues to process block 602 where a user is presented a promotional offer. The promotional offer is created by a promoter, for example a business or a marketer. The promotional offer can be any kind of coupon, discount, offer, contest entry, reward, or other promotion. The promotional offer is provided to the user with the condition that the user initiate certain promoter-specified social network actions to receive the offer, for example “Liking” a particular fan page on a social network as described in decision block 616. In a configuration, the promotional offer comprises a description of the promotion and a code, for example a bar code or QR code. For example, the promotional offer could be printed on marketing literature or signage on display at a store's point-of-sale terminal, near related products, or at a kiosk located in a store. The promotional offer can further comprise a URL, such as a shortened URL. Processing continues to decision block 604.

In decision block 604, if the user has a mobile device that can scan the code, for example by scanning a bar code or capturing an image of a QR code, and process the code to determine a URL appropriate for redirecting the browser of the mobile device to a the promoter's website or social networking fan page, then processing continues to process block 612. If the user does not have a mobile device capable of determining a URL from the code, then processing continues to process block 606. In process block 606 the user can enter the URL from the promotional offer into the user's mobile phone, a kiosk or special purpose computing device at the store if available, or any other local network connected computing device available to the user. The URL can be a shortened URL to allow the user to enter a short string of characters into the computing device to be directed to a promoter's website. For example, the URL can be “cou.pt”. Processing continues to process block 608. In process block 608, the website generates a temporary, unique bar code that is displayed to the user. In configurations, the bar code could be a QR code. The user can print out a copy of the bar code and take it to a point-of-sale terminal, or the display of the computing device can be presented at the point-of-sale terminal. Processing continues to process block 610. In process block 610 the bar code is presented at the point-of-sale terminal that can include a promotion verification system that can be integrated with the point-of-sale terminal. The bar code is scanned by either the point-of-sale terminal or the promotion verification system. For example, if using a mobile computing device, the bar code can be scanned from the screen of the mobile computing device. The bar code can be used, in conjunction with the promotion verification system, to identify the promotions available to the user, for example by identifying the store. Processing continues to process block 612. In an alternative configuration, the URL can be the URL appropriate for redirecting the browser of the mobile device to the promoter's website or social networking fan page, in which case after process block 606, processing continues directly to process block 612.

In process block 612, the user is prompted to connect to their social network account. If using a mobile computing device, and the user is logged on to their social network account, then the browser of the mobile computing device can be directed to the promoter's social networking fan page. If the user is not logged on to their social network account, the user will be prompted to log on to their social network account. Processing continues to decision block 614.

In decision block 614, if the user has previously “Liked” the promoter's social networking fan page, then processing continues to process block 620. If the user has not previously “Liked” the promoter's social networking fan page, then processing continues to process block, then processing continues to decision block 616. In decision block 616, the user can be presented with the terms of promotional offer, for example a coupon available only to users who have not previously “Liked” the promoter's social networking fan page. The user can also be presented with regular promotions if available. If the user clicks on the “Like” button, then processing continues at process block 618, otherwise processing continues to process block 620. Although the user's actions are described above as “Liking” a particular promoter's social networking fan page, it should be noted that the condition for receiving the promotional offer can be the successful completion of an action requested by the promoter, whether on the social network or through another means of social media, including but not limited to posting a particular promotion on the user's page as described in the systems 100, 200, 300, 400 above. In process block 618, the user can be presented a screen that allows them to click and claim the promotional offer. The promotional offer can be an enhanced promotion that has more value or a different promotion than the promoter's regular promotions. Processing continues to process block 622. In process block 620, the user can select one of the regular promotions available on the promoter's social networking fan page, if any are available. Processing continues to process block 622.

In process block 622, a bar code for the promotion is displayed. The bar code can be the enhanced promotion or a regular promotion. The bar code for the promotion can be displayed on the user's mobile computing device. In various configurations, the bar code for the promotion can be displayed on a local computing device or the bar code can printed out from a local computing device and taken to the point-of-sale terminal. Processing continues to process block 624. In process block 624, the bar code for the promotion is scanned by the point-of-sale terminal, or the promotion authentication system, for example by scanning the screen of the mobile computing device. Processing continues to decision block 626.

In decision block 626 the bar code for the promotion can be authenticated and verified for use by the user. The promotion can be checked to determine if the promotion has been previously used or has expired. If the promotion is authentic and has not expired or been previously used, processing continues to process block 630. If the bar code is for a promotion that is unauthorized, is expired, or has been used previously, or is otherwise invalid then processing continues to process block 628. In process block 628, the promotion is denied and the discount, or reward is not given to the user. In process block 630, the promotion is approved and the merchant or store is advised to allow the customer to receive the promotion, discount, or reward. In a configuration, merchant's or store's point-of-sale terminals are configured to permit the promotion to be used, and the discount or promotion applied to the amount due at the point-of-sale terminal, once the promotion has been approved. Operation concludes with end block 632 labeled END.

Although described as a promotional offer at a merchant's store or place of business, in configurations the promotion could be offered at other venues such as public events like fairs, and does not require a physical storefront to be present. The system and methods described allow a user to receive a promotional offer that is conditioned upon the performance a particular social network action. This can eliminate any temporal gap between when a user engages in a transaction with a promoter, store or merchant, and the user's normal social networking habits, thereby increasing the likelihood that the promoter, store or merchant will become a member of the user's social network.

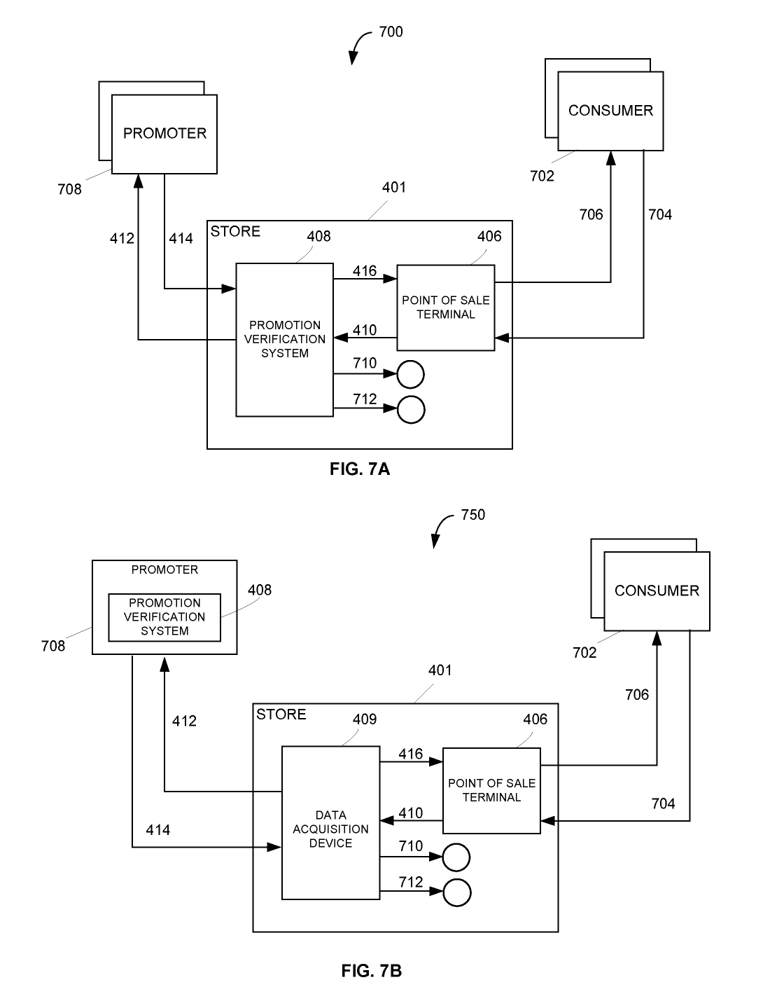

In FIG.7A, a block diagram of a real-time offer verification system 700 is presented. As described above, however, in other configurations the verification systems described herein may verify through a non-real-time process occurring subsequent to coupon redemption. A consumer 702 presents a coupon 704 at a store 401 to receive a discount on a product or service 706 when checking out of the store 401. For example, the consumer 702 can present a coupon 704 to a clerk or a merchant, or the consumer 702 can display it to an automated point-of-sale register at the store 401. The coupon can be the entire payment for the product or service, or the coupon can be a discount or other form of promotion or offer. The coupon 704 can be a printed coupon having a code, such as a bar code or QR code. In a configuration, the coupon 704 can be displayed on a user's mobile device and scanned by the point-of-sale terminal 406 or a promotion verification system 408.

A promotion verification system 408 at the store 401 allows the store 401 to verify and authenticate the coupon to ensure that the coupon is genuine and not, for example, an unauthorized copy, an expired coupon, or a coupon that has already been redeemed. When the consumer 702 presents the coupon 704 to a register clerk for redemption, for example when paying at a point-of-sale terminal 406, the clerk enters 410 the coupon information into the promotion verification system 408, for example by scanning a bar code on the coupon or any other authentication or identifying indicia on the coupon. The promotion verification system 408 can perform an authentication request 412 for the coupon with the promoter's authentication system 708. The promoter's authentication system 708 can comprise a database for validating coupons and other promotions, and a web server for accepting the authentication requests 412 and sending back authentication answers 414 to the promotion verification system 408. The promoter 112 can send an authentication answer 414 back to the promotion verification system 408 to indicated whether or not the coupon is authentic, has not-expired, and has not been previously redeemed by the consumer 702. In addition, the promotion verification system 408 or the merchant or store 401 can perform further verification as to whether or not the consumer 702 using the coupon has met all of the requirements for the coupon or promotion. For example, the coupon could be valid only for a particular consumer 702, and therefore the store 401 can check the consumer's 702 identify on a driver's license or other identification to verify the identity of the consumer 702.

If the promotion verification system 408 indicates that the coupon is valid, the promotion verification system 408 can flash a green light 710 to indicate that the coupon is valid, thereby providing a visual indication to a clerk to apply 416 the coupon to the current purchase at the point-of-sale terminal 406. The consumer 702 receives the products or services 706 at the discounted price. If the promotion verification system 408 indicates that the coupon is invalid, the promotion verification system 408 can flash a red light 712 to indicate that the coupon has not been accepted. By flashing a red light 712, the consumer 702 can be provided a visual indication that their coupon will not be accepted by the merchant or store 401. In a configuration, the point-of-sale terminal 406 and the promotion verification system 408 can be connected via a network connection or communications link so that the coupon can be directly applied 416 by the point-of-sale terminal 406 to the consumer's 702 current purchase.

In a configuration, the promotion verification system 408 can provide a number of indicator lights during the validation and authentication of the coupon. For example, the promotion verification system can provide a first indicator light to indicate when the authentication request 412 has been sent, a second indicator light to indicate the receipt and status of the authentication answer 414, a third indicator light to indicate the status of any further verification operations, a fourth indicator light to indicate that the coupon is valid and accepted, and a fifth indicator light to indicate that the coupon has been successfully applied to the purchase at the point-of-sale terminal. Other indications are also considered.

In FIG. 7B, a block diagram of an offer verification system 750 is presented. Similar to the offer verification system 700 in FIG. 7A, a consumer 702 presents a coupon 704 at a store 401 to receive a discount on a product or service 706 when checking out of the store 401. The coupon 704 can be a printed coupon having a code, such as a bar code or QR code. In a configuration, the coupon 704 can be displayed on a user's mobile device and scanned by the point-of-sale terminal 406 or a data acquisition device 409. The data acquisition device 409 can be any suitable device or module, such as a hand-held scanner. In some configurations, the data acquisition device 409 includes a web-based interface which also a coupon code to be manually entered. In some configurations, the data acquisition device 409 can be integrated into the point of sale terminal 406. As indicated by arrow 410, the data acquisition device 409 obtains the coupon information. The coupon information can be obtained, for example by scanning a bar code on the coupon or any other authentication or identifying indicia on the coupon.

Upon receiving coupon related data, the data acquisition device 409 can send an authentication request 412 to the promoter's authentication system 408. As illustrated, the promotion verification system 408 can be managed by the promoter 708. An authentication answer 414 is returned to the data acquisition device 409 to indicate whether or not the coupon is authentic, has not expired, and has not been previously redeemed by the consumer 702. As it to be appreciated, in some configurations, the authentication answer 414 can be sent to the point of sale terminal.

Similar to the offer verification system 700 in FIG. 7A, the promotion verification system 408 or the merchant or store 401 can perform further verification as to whether or not the consumer 702 using the coupon has met all of the requirements for the coupon or promotion. For example, the coupon could be valid only for a particular consumer 702, and therefore the store 401 can check the consumer's 702 identify on a driver's license or other identification to verify the identity of the consumer 702.

If the promotion verification system 408 indicates that the coupon is valid, the data acquisition device 408 can flash a green light 710 to indicate that the coupon is valid, thereby providing a visual indication to a clerk to apply 416 the coupon to the current purchase at the point-of-sale terminal 406. The consumer 702 receives the products or services 706 at the discounted price. If the promotion verification system 408 indicates that the coupon is invalid, the data acquisition device 409 can flash a red light 712 to indicate that the coupon has not been accepted. By flashing a red light 712, the consumer 702 can be provided a visual indication that their coupon will not be accepted by the merchant or store 401. In a configuration, the point-of-sale terminal 406 and the promotion verification system 408 can be connected via a network connection or communications link so that the coupon can be directly applied 416 by the point-of-sale terminal 406 to the consumer's 702 current purchase.

In a configuration, the data acquisition device 409 can provide a number of indicator lights during the validation and authentication of the coupon. For example, the promotion verification system can provide a first indicator light to indicate when the authentication request 412 has been sent, a second indicator light to indicate the receipt and status of the authentication answer 414, a third indicator light to indicate the status of any further verification operations, a fourth indicator light to indicate that the coupon is valid and accepted, and a fifth indicator light to indicate that the coupon has been successfully applied to the purchase at the point-of-sale terminal. Other indications are also considered.

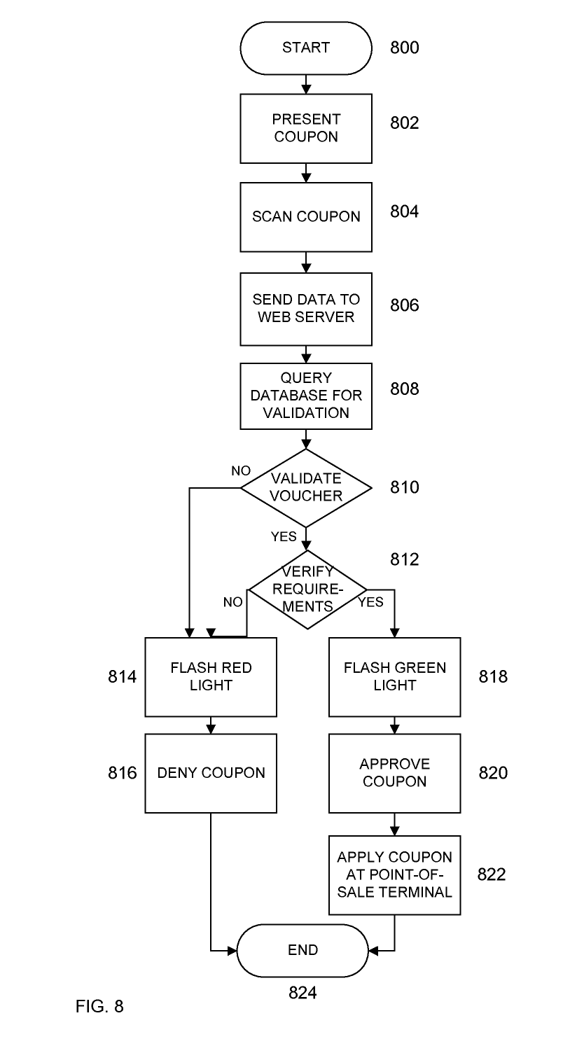

Referring now to FIG. 8, an exemplary flow diagram is presented of the operation of a real-time offer verification system. Operation starts with start block 800 labeled START. Processing continues to process block 802 where a consumer presents a coupon to a store or merchant. The coupon can be any kind of promotional offer, discount, offer, contest entry, reward, or other promotion. In a configuration, the coupon comprises a code, for example a bar code or QR code, and can identify the product, the discount, and the identity of the consumer. Processing continues to process block 804.

In process block 804, the code on the coupon is scanned. The scanning can be performed by a clerk or merchant at the store. The scanning can be performed at a point-of-sale terminal, for example by the consumer placing a mobile device displaying a bar code in front of a scanner of a point-of-sale terminal or a promotion verification system. The scanner can indicated to the consumer, clerk, or merchant that the code was received correctly, for example by flashing an indicator light or producing an audible sound. Processing continues to process block 806. In process block 806, the data represented by the code is sent to a web server, for example a promoter's web server or a third party provider web server for processing promotion authentications. Processing continues to block 808. In process block 808, a promotion authentication system validates the data represented by the code to validate the consumer's coupon. Processing continues to decision block 810.

In decision block 810, if the coupon is invalid, for example if the coupon is expired, or has already been redeemed, processing continues to process block 814. Processing then continues to process block 814. If the coupon is valid, then processing continues to decision block 812. In decision block 812, the promotion verification system, the point-of-sale system, and the store, merchant or clerk and perform additional validation and authentication of the coupon and consumer. For example, a clerk can verify the consumer's identity from the consumer's driver's license or other identification. If the consumer and coupon cannot be verified, then processing continues to process block 814. Otherwise, processing continues to process block 818.

In process block 814, the promotion verification system flashes one or more red lights to indicate to the user and the store that the coupon is not valid. In configurations, the indication that the coupon is invalid can include a solid light, a light of a different color other than red, an audible sound or playback of a message, a signal to a point-of-sale terminal, or any other indication of an invalid coupon. Processing continues to process block 816. In process block 816, the coupon is denied. For example, a point-of-sale terminal that is connected to the promotion authentication system can receive a signal from the promotion authentication system in process block 814 and deny the consumer's use of the coupon. In another example, a clerk may be unable to verify the identity of the consumer in decision block 812 and prohibit the consumer from applying the coupon and discount to the purchases. Operation concludes with end block 824 labeled END.

In process block 818, the promotion verification system flashes one or more green lights to indicate to the user and the store that the coupon is valid. In configurations, the indication that the coupon is valid can include a solid light, a light of a different color other than green, an audible sound or playback of a message, a signal to a point-of-sale terminal, or any other indication of a valid coupon. Processing continues to process block 820. In process block 820, the coupon is approved for use in the current purchase or transaction with the consumer. Processing continues to process block 822. In process block 822, the coupon or the discount for using the coupon is applied to the current purchase or transaction with the consumer. For example, a clerk may apply the discount to the purchase price owed by the consumer. In another example, if the promotion verification system is networked to the point-of-sale terminal, the discount can be applied directly. Operation concludes with end block 824 labeled END.

These and other embodiments of the systems and methods for incentivizing the sharing of promotions through social networks can be used for incentivizing other forms of social networking behavior and sharing of promotions and information through other media and venues as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

In general, it will be apparent to one of ordinary skill in the art that at least some of the embodiments described herein may be implemented in many different embodiments of software, firmware, and/or hardware. The software and firmware code may be executed by a processor or any other similar computing device. The software code or specialized control hardware that may be used to implement embodiments is not limiting. For example, embodiments described herein may be implemented in computer software using any suitable computer software language type, using, for example, conventional or object-oriented techniques. Such software may be stored on any type of suitable computer-readable medium or media, such as, for example, a magnetic or optical storage medium. The operation and behavior of the embodiments may be described without specific reference to specific software code or specialized hardware components. The absence of such specific references is feasible, because it is clearly understood that artisans of ordinary skill would be able to design software and control hardware to implement the embodiments based on the present description with no more than reasonable effort and without undue experimentation.

Moreover, the processes associated with the present embodiments may be executed by programmable equipment, such as computers or computer systems and/or processors. Software that may cause programmable equipment to execute processes may be stored in any storage device, such as, for example, a computer system (nonvolatile) memory, an optical disk, magnetic tape, or magnetic disk. Furthermore, at least some of the processes may be programmed when the computer system is manufactured or stored on various types of non-transitory computer-readable media, such as, a hard drive, compact disc, flash memory, and volatile memory, for example.

It can also be appreciated that certain process aspects described herein may be performed using instructions stored on a computer-readable medium or media that direct a computer system to perform the process steps. A computer-readable medium may include, for example, memory devices such as diskettes, compact discs (CDs), digital versatile discs (DVDs), optical disk drives, or hard disk drives. A computer-readable medium may also include memory storage that is physical, virtual, permanent, temporary, semipermanent, and/or semitemporary.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a computer, a firmware element embedded in hardware, or any combination thereof.

What is claimed is:

1. A non-transitory computer readable medium having instructions stored thereon which when executed by a processor cause the processor to:
receive a promotion validation request for a promotion claimed by a claimant, wherein the promotion validation request comprises a unique electronic promotion code, wherein the unique promotion coupon code is associated with an identity of a claimant;
validate the unique electronic coupon code;
when the unique electronic promotion code is validated, transmit an approval message; and
when the electronic promotion code is not validated, transmit a denial message.

2. The non-transitory computer readable medium of claim 1, wherein the claimant of the promotion received the promotion through a social networking website.

3. The non-transitory computer readable medium of claim 1, wherein the non-transitory computer readable medium has instructions stored thereon which when executed by a processor cause the processor to:
post the promotion on the social networking website.

4. The non-transitory computer readable medium of claim 1, wherein the unique coupon code is printed on the promotion in a computer-readable format.

5. The non-transitory computer readable medium of claim 4, wherein the computer-readable format is one of a bar code and a quick response (QR) code.

6. The non-transitory computer readable medium of claim 4, wherein the promotion validation request is received from a hand-held scanner.

7. A computer-based method, comprising:
posting, to a social networking website of a first user, a first promotional posting, the first promotional posting selected by the user from a plurality of promotional offerings from an offering entity;
after posting the first promotion to the social networking website of the first user, presenting the first user with a first promotional coupon, the first promotional coupon comprising one of the plurality of promotional offerings from the offering entity, the first promotional coupon comprising a first authorization code;
storing in a database an indication that the first promotional coupon comprising the first authorization code was presented to the first user;
after presenting the first user with the first promotional coupon, receiving a first validation request for the first promotional coupon, wherein the first validation request comprises the first authorization code; and
validating the first promotional coupon.

8. The computer-based method of claim 7, wherein presenting the first user with the first promotional coupon comprises at least one of providing the promotional coupon using a uniform resource locator (URL) link and providing the promotional coupon though an email communication.

9. The computer-based method of claim 7, comprising:
receiving a request from the first user to post the first promotional posting on a social networking website of a second user, wherein the second user is associated with the first user through the social network website; and
posting, to the social networking website of the second user, the first promotional posting.

10. The computer-based method of claim 9, comprising:
receiving a request from the second user to post the first promotional posting on a social networking website of a third user, wherein the third user is associated with the second user through the social network website; and
posting, to the social networking site of the third user, the first promotional posting.

11. The computer-based method of claim 10, comprising:
after posting the first promotion to the social networking website of the third user, presenting the second user with a second promotional coupon, the second promotional coupon comprising one of the plurality of promotional offerings from the offering entity, the second promotional coupon comprising a second authorization code, wherein the second authorization code is different than the first authorization code;
storing in a database an indication that the second promotional coupon comprising the second authorization code was presented to the second user;
after presenting the second user with the second promotional coupon, receiving a second validation request for the second promotional coupon, wherein the second validation request comprises the second authorization code;; and
validating the promotional coupon.

12. A non-transitory computer readable medium having instructions stored thereon which when executed by a processor cause the processor to:
display a plurality of promotional offerings;
receive from a first user a selection of one of the plurality of promotional offerings;
post, to a web page of an online social network, the selected promotional offering;
after posting the promotional offering to the web page of the online social network, providing the first user with a coupon for one of the plurality of promotional offerings, the coupon comprising a unique code associated with the identity of the first user.

13. The non-transitory computer readable medium of claim 12, wherein the web page of the online social network is the associated with the first user.

14. The non-transitory computer readable medium of claim 12, wherein the web page of the online social network is the associated with a second user.

15. The non-transitory computer readable medium of claim 14, wherein the non-transitory computer readable medium has instructions stored thereon which when executed by a processor cause the processor to:
receive from the second user, an indication of a plurality of members within the online social network of the second user, wherein each of a plurality of members are associated with a web page of the online social network;
post, to the web page of each of the plurality of members, a promotional offering.

16. The non-transitory computer readable medium of claim 15, the non-transitory computer readable medium has instructions stored thereon which when executed by a processor cause the processor to:
when the number of web pages to which the promotional offering has been posted exceeds a threshold number, presenting the second user with coupon, the coupon comprising unique identifying indicia.

17. The non-transitory computer readable medium of claim 16, the non-transitory computer readable medium has instructions stored thereon which when executed by a processor cause the processor to:
receive an authorization request to authorize the coupon.
